(19) United States
(12) Patent Application Publication
(10) Pub. No.: US 2026/0186671 A1
(43) Pub. Date: Jul. 2, 2026

(54) MEMORY MANAGEMENT METHOD AND STORAGE DEVICE

(71) Applicant: Hosin Global Electronics Co., LTD, Shenzhen (CN)

(72) Inventors: Siu Tung LAM, Shenzhen (CN); Xuelou HUANG, Shenzhen (CN); Donglin CHEN, Shenzhen (CN); XiaoGang Lu, Shenzhen (CN); JianXiong Hao, Shenzhen (CN); ZeMing Cai, Shenzhen (CN)

(73) Assignee: Hosin Global Electronics Co., LTD, Shenzhen (CN)

(21) Appl. No.: 19/382,193

(22) Filed: Nov. 6, 2025

(30) Foreign Application Priority Data
Dec. 30, 2024 (CN) 202411962783.1

(51) Int. Cl. G06F 3/06

(52) U.S. Cl. CPC G06F 3/0623; G06F 3/0652; G06F 3/0659; G06F 3/0679

(57) ABSTRACT

The present invention provides a memory management method and a storage device. The method includes: sending a read command sequence to a memory module to instruct reading of a first physical unit among a plurality of physical units; obtaining read data corresponding to the read command sequence from the memory module; performing an error detection on the read data to obtain error rate information of the read data; generating encryption information according to the error rate information; encrypting original data according to the encryption information to generate encrypted data corresponding to the original data; and sending a write command sequence to the memory module to instruct storing of the encrypted data to a second physical unit among the physical units.

### CROSS-REFERENCE TO RELATED APPLICATION

This application claims the priority benefit of Chine application serial no. 202411962783.1, filed on Dec. 30, 2024. The entirety of the above-mentioned patent application is hereby incorporated by reference herein and made a part of this specification.

### BACKGROUND

### Technical Field

The present invention relates to the field of storage technology, and in particular to a memory management method and a storage device.

### Description of Related Art

In today's highly digitalized era, with the rapid advancement of information technology and the increasing prominence of big data value, data security has become an indispensable core element in storage system design. Traditional hard disk drives (HDDs) and early solid-state drives (SSDs), due to their lack of comprehensive security mechanisms, are relatively vulnerable to risks of unauthorized access and data leakage. Especially in emerging application scenarios such as cloud computing and edge computing, these storage devices struggle to meet the stringent requirements for data integrity, confidentiality, and regulatory compliance.

To address these challenges, data encryption technologies have gradually become the mainstream approach for protecting sensitive information. Among them, hardware-based encryption solutions have gained widespread attention in the industry for their ability to deliver both high performance and robust security. Against this backdrop, encrypted solid-state drives (Encrypted SSDs) have emerged. These products not only inherit the high-speed access advantages of traditional SSDs but also integrate advanced encryption algorithms and key management mechanisms, thereby providing users with a storage platform that ensures both efficiency and security.

As a result, the development and optimization of encrypted SSDs have become an important direction of technological evolution in the storage field, and a critical pathway to safeguarding data security.

### SUMMARY

The present invention provides a memory management method and a storage device, which can improve the above-mentioned problem and enhance the data encryption efficiency of the storage device.

A memory management method for a storage device is provided according to an embodiment of the invention. The storage device includes a memory module. The memory module includes a plurality of physical units. The memory management method comprises the following steps. A read command sequence is sent to the memory module to instruct reading of a first physical unit among the physical units. Read data corresponding to the read command sequence is obtained from the memory module. An error detection is performed on the read data to obtain error rate information of the read data, wherein the error rate information reflects a bit error rate of the read data. Encryption information is generated according to the error rate information. Original data is encrypted according to the encryption information to generate encrypted data corresponding to the original data. A write command sequence is sent to the memory module to instruct storing of the encrypted data in a second physical unit among the physical units.

A storage device is provided according to an embodiment of the invention. The storage device includes a connection interface, a memory module and a memory controller. The connection interface is configured to connect to a host system. The memory controller is connected to the connection interface and the memory module. The memory module includes a plurality of physical units. The memory controller is configured to: send a read command sequence to the memory module to instruct reading of a first physical unit among the physical units; obtain read data corresponding to the read command sequence from the memory module; perform an error detection on the read data to obtain error rate information of the read data, wherein the error rate information reflects a bit error rate of the read data; generate encryption information according to the error rate information; encrypt original data according to the encryption information to generate encrypted data corresponding to the original data; and send a write command sequence to the memory module to instruct storing of the encrypted data in a second physical unit among the physical units.

Based on the above, the present invention can effectively improve the problem that the random numbers traditionally used to encrypt data are not random enough, thereby improving the data encryption efficiency of the storage device.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a data storage system according to an embodiment of the present invention.

FIG. 2 is a schematic diagram of a memory controller according to an embodiment of the present invention.

FIG. 3 is a schematic diagram of managing memory module according to an embodiment of the present invention.

FIG. 4 is a schematic diagram showing generation of encryption information according to an embodiment of the present invention.

FIG. 5 is a schematic diagram showing generation of encryption information according to an embodiment of the present invention.

FIG. 6 is a flowchart of a memory management method according to an embodiment of the present invention.

FIG. 7 is a flowchart of a memory management method according to an embodiment of the present invention.

### DESCRIPTION OF THE EMBODIMENTS

Reference will now be made in detail to exemplary embodiments of the present invention, examples of which are illustrated in the accompanying drawings. Wherever possible, the same reference numbers are used in the drawings and the description to refer to the same or like parts.

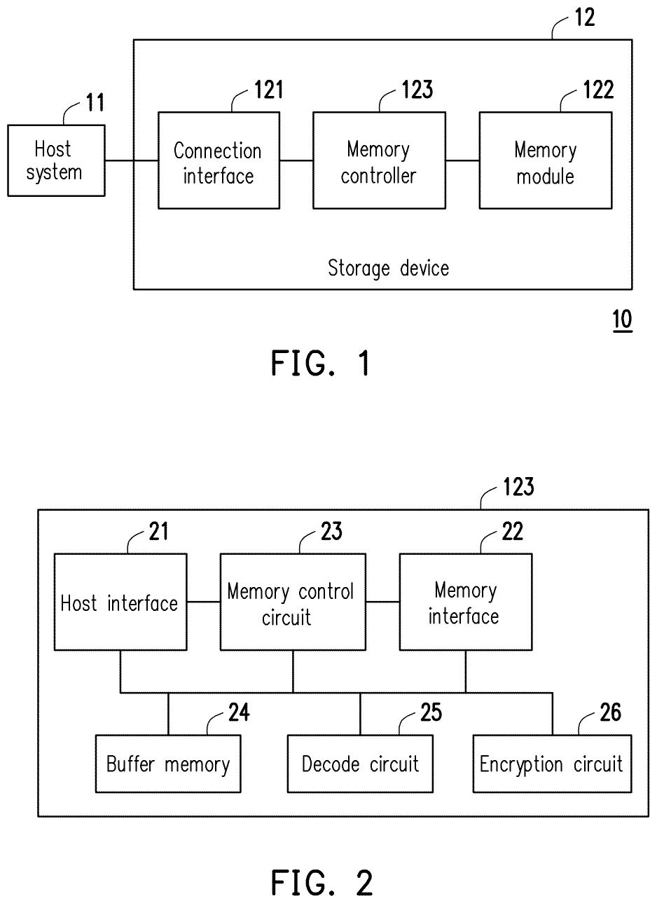

FIG. 1 is a schematic diagram of a data storage system according to an embodiment of the present invention. Referring to FIG. 1, data storage system 10 includes a host system 11 and a storage device 12. The storage device 12 may be connected to the host system 11 and configured to store data from the host system 11. For example, the host system 11 may be a smartphone, a tablet computer, a notebook computer, a desktop computer, an industrial computer, a game console, a server, or a computer system installed in a specific carrier (such as a vehicle, aircraft, or ship), and the type of the host system 11 is not limited thereto. In addition, the storage device 12 may include a solid-state drive, a USB flash drive, a memory card, or other types of non-volatile storage devices.

The storage device 12 includes a connection interface 121, a memory module 122 and a memory controller 123. The connection interface 121 is configured to connect the storage device 12 to the host system 11. For example, the connection interface 121 may support an embedded Multi-Media Card (eMMC), Universal Flash Storage (UFS), Peripheral Component Interconnect Express (PCI Express), Non-Volatile Memory Express (NVM express), Serial Advanced Technology Attachment (SATA), Universal Serial Bus (USB), or other types of connection interface standards. Thus, the storage device 12 may communicate (e.g., exchange signals, instructions, and/or data) with the host system 11 via the connection interface 121.

The memory module 122 is configured to store data. For example, the memory module 122 may include one or more rewritable non-volatile memory modules. Each rewritable non-volatile memory module may include one or more memory cell arrays. The memory cell in the memory cell arrays stores data in the form of voltage (also referred to as threshold voltage). For example, the memory module 122 may include a single-level memory cell (SLC) NAND-type flash memory module, a multi-level memory cell (MLC) NAND-type flash memory module, a triple-level memory cell (TLC) NAND-type flash memory module, a quad-level memory cell (QLC) NAND-type flash memory module, and/or other memory modules having the same or similar characteristics.

The memory controller 123 is connected to the connection interface 121 and the memory module 122. The memory controller 123 can be regarded as a control core of the storage device 12 and is configured to control the storage device 12. For example, the memory controller 123 may be configured to control or manage the entire or partial operation of the storage device 12. For example, the memory controller 123 may include a central processing unit (CPU), or other programmable general-purpose or special-purpose microprocessor, digital signal processor (DSP), programmable controller, application specific integrated circuits (ASIC), programmable logic device (PLD), or other similar devices or a combination of these devices. In an embodiment, the memory controller 123 may include a flash memory controller.

The memory controller 123 may send a command sequence to the memory module 122 to access the memory module 122. For example, the memory controller 123 may send a write command sequence to the memory module 122 to instruct the memory module 122 to store data in a specific memory cell. For example, the memory controller 123 may send a read command sequence to the memory module 122 to instruct the memory module 122 to read data from a specific memory cell. For example, the memory controller 123 may send an erase command sequence to the memory module 122 to instruct the memory module 122 to erase data stored in a specific memory cell. In addition, the memory controller 123 may also send other types of command sequences to the memory module 122 to instruct the memory module 122 to perform other types of operations, which is not limited in the present invention. The memory module 122 may receive a command sequence from the memory controller 123 and access a memory cell within the memory module 122 according to the command sequence.

FIG. 2 is a schematic diagram of a memory controller according to an embodiment of the present invention. Please referring to FIG. 1 and FIG. 2, the memory controller 123 includes a host interface 21, a memory interface 22, and a memory control circuit 23. The host interface 21 is connected to the host system 11 through the connection interface 121 to communicate with the host system 11. The memory interface 22 is configured to connect to the memory module 122 to access the memory module 122.

The memory control circuit 23 is connected to the host interface 21 and the memory interface 22. The memory control circuit 23 may be configured to control or manage the entire or partial operation of the memory controller 123. For example, the memory control circuit 23 may communicate with the host system 11 through the host interface 21 and access the memory module 122 through the memory interface 22. For example, the memory control circuit 23 may include an embedded controller or a microcontroller. In the following embodiments, the description of the memory control circuit 23 can be equivalent to the description of the memory controller 123.

In one embodiment, the memory controller 123 may further include a buffer memory 24. The buffer memory 24 is connected to the memory control circuit 23 and is configured to cache data. For example, the buffer memory 24 may be configured to cache instructions from the host system 11, data from the host system 11, and/or data from the memory module 122.

In one embodiment, the memory controller 123 may further include a decode circuit 25. The decode circuit 25 is connected to the memory control circuit 23 and is configured to encode and decode data to ensure data accuracy. For example, decode circuit 25 may support various encoding/decoding algorithms, such as low-density parity check code (LDPC code), BCH code, Reed-Solomon code (RS code), and exclusive OR (XOR) code.

In one embodiment, the memory controller 123 may further include an encryption circuit 26. The encryption circuit 26 is connected to the memory control circuit 23 and is configured to encrypt and decrypt data to ensure the confidentiality of the data. For example, after specific data (also referred to as first data) is encrypted by the encryption circuit 26, a ciphertext corresponding to the first data may be generated. After the ciphertext is decrypted by the encryption circuit 26, the plaintext corresponding to the ciphertext (i.e., the first data) can be restored.

In one embodiment, the encryption circuit 26 may support symmetric encryption algorithms, asymmetric encryption algorithms, or other types of encryption/decryption algorithms. For example, the symmetric encryption algorithms may include AES (Advanced Encryption Standard)-256, etc., and the asymmetric encryption algorithm may include RSA (Rivest-Shamir-Adleman), etc., however, the present invention is not limited thereto. In one embodiment, the memory controller 123 may further include other types of circuit modules (such as a power management circuit, etc.), which is not limited in the present invention.

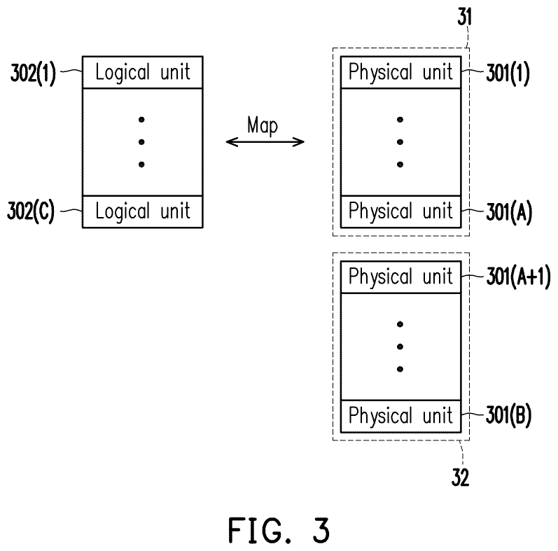

FIG. 3 is a schematic diagram of managing memory module according to an embodiment of the present invention. Please referring to FIG. 1 to FIG. 3, the memory module 122 includes a plurality of physical units 301(1) to 301(B). Each physical unit includes multiple memory cells and is configured to store data in a non-volatile manner.

In one embodiment, a physical unit may include one or more physical erasing units. In addition, a physical unit may include multiple physical sub-units. For example, a physical sub-unit may include one or more physical programming units.

In one embodiment, a physical programming unit may include multiple physical sectors. For example, the data capacity of a physical sector may be 512 bytes (B), and a physical programming unit may include 32 physical sectors. However, the data capacity of a physical sector and/or the total number of physical sectors included in one physical programming unit can be adjusted according to practical needs, and the present invention is not limited thereto. In one embodiment, a physical programming unit may be considered as a physical page. For example, the storage capacity of one physical programming unit may be 16 kilobytes (KB), but the present invention is not limited thereto.

In one embodiment, a physical programming unit is the smallest unit for synchronously writing data in the memory module 122. For example, when a programming operation (also referred to as a write operation) is performed on a physical programming unit to write data into the physical programming unit, multiple memory cells in the physical programming unit may be synchronously programmed to store corresponding data. For example, when programming a physical programming unit, write voltages may be applied to the physical programming unit to change the threshold voltage of at least a portion of the memory cells in the physical programming unit. For example, the threshold voltage of a memory cell may reflect the bit data stored in the memory cell.

In one embodiment, a physical erasing unit may include multiple physical programming units. Multiple physical programming units in one physical erasing unit can be erased simultaneously. For example, when performing an erasing operation on a physical erasing unit, erasing voltages may be applied to a plurality of physical programming units in the physical erasing unit to change the threshold voltage of at least some memory cells in the physical programming units. By performing the erasing operation on a physical erasing unit, the data stored in the physical erasing unit can be cleared (i.e., erased).

In one embodiment, the memory control circuit 23 can logically associate the physical units 301(1)-301(A) and 301(A+1)-301(B) with the data region 31 and the spare region 32, respectively. The physical units 301(1) to 301(A) in data region 31 store data from host system 11 (also referred to as user data). For example, each physical unit in the data region 31 can store valid data and/or invalid data. In addition, none of the physical units 301(A+1)-301(B) in the spare region 32 stores data (e.g., valid data).

In one embodiment, if a physical unit does not store valid data, the physical unit may be associated to the spare region 32. In addition, the physical units in the spare region 32 can be erased to clear the data in the physical units. In one embodiment, the physical units in the spare region 32 may also be referred to as spare physical units. In one embodiment, the spare region 32 may also be referred to as free pool.

In one embodiment, when data is to be stored, the memory control circuit 23 may select one or more physical units from the spare region 32 and instruct the memory module 122 to store the data in the selected physical unit(s). After storing data in the physical unit(s), the physical unit(s) can be associated to the data region 31. In other words, one or more physical units can be used alternately between the data region 31 and the spare region 32.

In one embodiment, the memory control circuit 23 may configure a plurality of logical units 302(1) to 302(C) to map the physical units (i.e., physical units 301(1) to 301(A)) in the data region 31. For example, a logical unit may correspond to a logical block address (LBA) or other logical management units. A logical unit can be mapped to one or more physical units.

In one embodiment, if a physical unit is currently mapped by any logical unit, the memory control circuit 23 may determine that the data currently stored in this physical unit includes valid data. On the contrary, if a physical unit is not currently mapped by any logical unit, the memory control circuit 23 may determine that this physical unit does not currently store any valid data.

In one embodiment, the memory control circuit 23 may record mapping relationships between the logical units and the physical units in at least one management table (also referred to as logical-to-physical mapping table). In one embodiment, the memory control circuit 23 may instruct the memory module 122 to perform operations such as data read, write, or erase according to the information in the management table (i.e., the logical-to-physical mapping table).

In one embodiment, the memory control circuit 23 may send a read command sequence to the memory module 122. The read command sequence may be configured to instruct the memory module 122 to read at least one physical unit (also referred to as a first physical unit). For example, the first physical unit may include at least one of the physical units 301(1)-301(A) in FIG. 3. According to the read result of the memory module 122, the memory control circuit 23 can obtain the read data corresponding to the read command sequence from the memory module 122. For example, assuming that the first physical unit is the physical unit 301(i) in FIG. 3, the read data may reflect a reading result of the memory module 122 with respect to the physical unit 301(i).

In one embodiment, after obtaining the read data, the memory control circuit 23 may perform error detection on the read data. The error detection is configured to obtain error rate information of the read data. The error rate information may reflect a bit error rate (BER) of the read data. For example, the error rate information (i.e., the bit error rate) may reflect a specific number of error bit(s) existing in a predetermined amount of read data.

It is noted that, the error detection can be performed by the memory control circuit 23 or by the memory control circuit 23 with the decode circuit 25. However, in one embodiment, the error detection does not include error correction, performed by the decode circuit 25, on the read data. For example, the error correction is configured to correct error(s) (i.e., error bit(s)) in the read data.

That is, in one embodiment, the memory control circuit 23 may only perform error detection on the read data to obtain the error rate information without performing error correction on the read data. Thus, the power consumption of the storage device 12 can be saved.

In one embodiment, after obtaining the error rate information, the memory control circuit 23 may generate encryption information according to the error rate information. Taking the AES-256 encryption algorithm as an example, the encryption information may include key information and initialization sequence information. The key information may carry information of a key used to perform encryption in the AES-256 encryption algorithm. The initialization sequence information may carry information of initialization sequence (also referred to as initialization vector) used to perform encryption in the AES-256 encryption algorithm. It is noted that, the content of the encryption information may vary depending on different encryption algorithms, and the present invention is not limited thereto.

In one embodiment, after obtaining the encryption information, the encryption circuit 26 may encrypt data (also referred to as original data) according to the encryption information to generate encrypted data corresponding to the original data. Taking the AES-256 encryption algorithm as an example, the encryption circuit 26 may encrypt the original data, based on the AES-256 encryption algorithm, according to the encryption information to generate the encrypted data. It is noted that, the encryption circuit 26 may also use other encryption algorithms to encrypt the original data, and the present invention is not limited thereto.

In one embodiment, after obtaining the encrypted data, the memory control circuit 23 may send a write command sequence to the memory module 122. The write command sequence may be configured to instruct the memory module 122 to store the encrypted data in at least one physical unit (also referred to as second physical unit). For example, assuming that the first physical unit is the physical unit 301(i) in FIG. 3, then the second physical unit may be the physical unit 301(j) in FIG. 3, and i is different from j. Alternatively, in one embodiment, i may be equal to j.

It is noted that, in the aforementioned embodiment, the accuracy of each data read from the first physical unit (or the bit error rate) is affected by the current operation state of the memory module 122. For example, the operation state includes a read voltage applied to the first physical unit, a time duration of applying the read voltage, a threshold voltage distribution of multiple memory cells in the first physical unit, an environment temperature, and/or a clock frequency, and the type of the operation state is not limited thereto. Therefore, at different time points, based on the current operation status of the memory module 122, the read results for the first physical unit may be different. Therefore, compared with a conventional pseudo random number generator (PRNG) and/or true random number generator (TRNG), the bit error rate of the read result can be closer to a true random number (i.e., cannot be accurately predicted).

In one embodiment, encryption information is obtained based on the bit error rate of the read data, and the original data is encrypted using the obtained encryption information. This approach can mitigate deficiencies of pseudo random number generator (PRNG) and/or true random number generator (TRNG), such as insufficient randomness or the presence of detectable patterns, and thereby improving subsequent data-encryption effectiveness and increasing the difficulty of decrypting the encrypted data. Thus, the data storage security of the storage device 12 can be effectively improved.

In one embodiment, after obtaining the error rate information, the memory control circuit 23 may perform information processing (also referred to as first information processing) on the error rate information to obtain reference information (also referred to as first reference information). In particular, the first reference information may complies with a default data format, and the default data format matches the encryption algorithm configured to generate the encryption information. For example, assuming that the encryption algorithm is AES-256, the default data format may match the AES-256 encryption algorithm. For example, the default data format may be configured to standardize a data length of the first reference information to a preset length to meet subsequent computational requirements for the AES-256 encryption algorithm. Then, the memory control circuit 23 may generate the encryption information according to the first reference information.

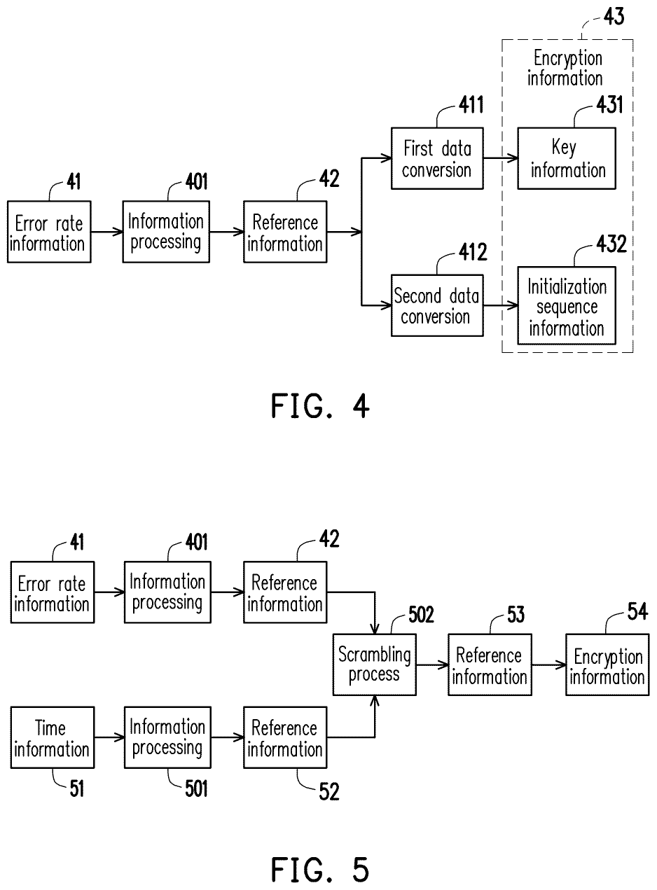

FIG. 4 is a schematic diagram showing generation of encryption information according to an embodiment of the present invention. Please referring to FIG. 4, the memory control circuit 23 may obtain error rate information 41. For example, the error rate information 41 may reflect the bit error rate of the read data read from the first physical unit. For example, the error rate information 41 may include a value or a data sequence to reflect the bit error rate of the read data.

After obtaining the error rate information 41, the memory control circuit 23 may perform information processing 401 (i.e., the first information processing) on the error rate information 41 to obtain reference information 42 (i.e., the first reference information). For example, in the information processing 401, the memory control circuit 23 may perform various operations on the error rate information 41, such as taking a logarithm (e.g., a natural logarithm), taking an absolute value, extracting at least a portion of the value after the decimal point, removing at least a portion of the value after the decimal point, performing a unit conversion, executing a polynomial operation, performing a hash operation, or applying other customized processing. The specific operation details of the information processing 401 can be set according to the encryption algorithm being used, and the present invention is not limited thereto. Based on a result of the information processing 401, the memory control circuit 23 can obtain reference information 42. Similar to the error rate information 41, the reference information 42 may approximate a true random number (i.e., a value that cannot be accurately predicted).

In one embodiment, after obtaining the reference information 42, the memory control circuit 23 may generate encryption information 43 according to the reference information 42. For example, taking the AES-256 encryption algorithm as an example, the encryption information 43 may include key information 431 and initialization sequence information 432.

In one embodiment, the memory control circuit 23 may perform data conversion (also referred to as first data conversion) 411 on the reference information 42 to obtain the key information 431. For example, key information 431 may carry information of a key used to perform encryption in an encryption algorithm used by encryption circuit 26. In addition, the memory control circuit 23 may perform another data conversion (also referred to as second data conversion) 412 on the reference information 42 to obtain initialization sequence information 432. For example, the initialization sequence information 432 may carry information of an initialization sequence (or initialization vector) used to perform encryption in the encryption algorithm used by the encryption circuit 26.

In one embodiment, the data format (e.g., data length) of the key information 431 may be different from the data format (e.g., data length) of the initialization sequence information 432. For example, taking the AES-256 encryption algorithm as an example, the data length of the key information 431 and the data length of the initialization sequence information 432 used in the AES-256 encryption algorithm may be “256” bits and “128 bits”, respectively. However, the data formats of the key information 431 and/or the initialization sequence information 432 may be adjusted according to practical requirements, and the present invention is not limited thereto.

It is noted that, in the embodiment of FIG. 4, the information processing 401, the first data conversion 411, and the second data conversion 412 may all be set or configured according to the encryption algorithm used by encryption circuit 26. Thus, the information processing 401, the first data conversion 411, and the second data conversion 412 can be used to generate the reference information 42, the key information 431, and the initialization sequence information 432, respectively, that match the encryption algorithm used by encryption circuit 26.

In one embodiment, the memory control circuit 23 can also obtain time information. The time information may reflect an average execution time of erasing operation for multiple physical units in the memory module 122. For example, the execution time of an erasing operation performed on a physical unit refers to the elapsed time from the start of the erasing operation on the physical unit until the erasing operation ends or is completed. Then, the memory control circuit 23 may generate the encryption information according to the error rate information and the time information.

In one embodiment, the execution time of each erasing operation performed by the memory module 122 is affected by the current operation state of the memory module 122. For example, the operation state includes an erasing voltage being applied, a time duration of applying the erasing voltage, a threshold voltage distribution of multiple memory cells being erased, an environment temperature, and/or a clock frequency, and the type of the operation state is not limited thereto. Therefore, at different time points, based on the current operation status of the memory module 122, the execution time of the erasing operation may also be different.

In one embodiment, the encryption information is generated by combining the error rate information with the time information, which can further enhance the randomness of the encryption information, thereby improving subsequent data encryption efficiency and increasing the resistance of the encrypted data to cryptanalysis. Thus, the data storage security of the storage device 12 can be more effectively improved.

In one embodiment, the memory control circuit 23 may perform an erasing operation on at least one of the physical units in the memory module 122. For example, in the erasing operation performed on the physical unit 301(k) of FIG. 3, the memory module 122 may apply erasing voltages to each memory cell (or physical sub-unit) in the physical unit 301(k). The erasing operation (or the applied erasing voltage) may be used to clear data stored in the physical unit 301(k). Furthermore, in response to the erasing operation being performed, the memory control circuit 23 may update the time information.

In one embodiment, the memory control circuit 23 may continuously monitor the usage status of the memory module 122 to obtain a total execution time of the erasing operation executed on each physical unit in the memory module 122. Then, the memory control circuit 23 may obtain (or update) the time information according to the total number of physical units in the memory module 122 and the total execution time. Thus, the acquired or updated time information can reflect the average execution time of the erasing operation for the physical units in real time.

In one embodiment, it is assumed that at a certain time point, the total execution time of erasing operations performed on multiple physical units in the memory module 122 is counted as “22451” microseconds (us), and the total number of physical units in the memory module 122 is “1727”. The memory control circuit 23 may obtain (or update) the time information according to the total execution time (i.e., “22451 microseconds”) and the total number of physical units (i.e., “1727”). For example, the obtained or updated time information may reflect that the average execution time of the erasing operations for the physical units is “374.1833333333333333333 seconds”.

In one embodiment, after obtaining the time information, the memory control circuit 23 may perform information processing (also referred to as second information processing) on the time information to obtain reference information (also referred to as second reference information). Similar to the first reference information, the second reference information also complies with the default data format. Taking the AES-256 encryption algorithm as an example, the default data format can be used to standardize the data length of the second reference information to a preset length to meet subsequent calculation requirements for the AES-256 encryption algorithm. Then, the memory control circuit 23 may generate the encryption information according to the first reference information and the second reference information. Thereby, the randomness of the encryption information can be further improved.

FIG. 5 is a schematic diagram showing generation of encryption information according to an embodiment of the present invention. Please referring to FIG. 5, after obtaining the error rate information 41, the memory control circuit 23 may perform information processing 401 on the error rate information 41 to obtain reference information 42. For relevant operation details, please refer to the embodiment of FIG. 4, which will not be repeated here.

In one embodiment, the memory control circuit 23 can obtain the time information 51. For example, the time information 51 may reflect the average execution time of the erasing operations for the multiple physical units. For example, the average execution time may be obtained based on the total execution time of at least one erasing operation executed on the physical units in the past and the total number of the physical units (e.g., obtained by dividing the total execution time by the total number). For example, the time information 51 may include a value or a data sequence to reflect the average execution time.

After obtaining the time information 51, the memory control circuit 23 may perform information processing 501 (i.e., second information processing) on the time information 51 to obtain reference information 52 (i.e., the second reference information). For example, in the information processing 501, the memory control circuit 23 may perform operations on the time information 51, such as extracting at least a portion of the value after the decimal point, removing at least a portion of the value after the decimal point, performing a unit conversion, executing a polynomial operation, performing a hash operation, or applying other customized processing. The specific operation details of information processing 501 can be set according to the encryption algorithm used, and the present invention is not limited thereto. Based on the result of information processing 501, the memory control circuit 23 can obtain reference information 52. For example, assuming that the time information 51 includes “374.18333333333333333333 (seconds)”, after extracting at least part of the numerical value after the decimal point of the time information 51, the reference information 52 may include “1833333333333333333”. Similar to the time information 51, the reference information 52 may approximate a true random number (i.e., a value that cannot be accurately predicted).

In one embodiment, after obtaining the reference information 42 and 52, the memory control circuit 23 may perform scrambling process 502 on the reference information 42 and 52 to obtain reference information 53 (i.e., the third reference information). For example, in the scrambling process 502, the memory control circuit 23 may perform an exclusive-OR (XOR) operation on the data sequence in the reference information 42 (also referred to as first data sequence) and the data sequence in the reference information 52 (also referred to as second data sequence) to obtain the reference information 53. The reference information 53 may reflect the operation result of the XOR operation. For example, the data sequence in the reference information 53 (also referred to as the third data sequence) may include multiple bits. Each bit in the reference information 53 may reflect the result of performing the XOR operation on the bits at corresponding positions in the reference information 42 and 52. It is noted that, the scrambling process 502 may also include logical addition or other types of logical operations, which are not limited in the present invention. Thereby, the randomness of the encryption information can be further improved.

After obtaining the reference information 53, the memory control circuit 23 may generate encryption information 54 according to the reference information 53. It is noted that, the details of the operation of generating the encryption information 54 based on reference information 53 can refer to the description of generating the encryption information 43 based on the reference information 42 in the embodiment of FIG. 4, or can be adjusted according to practical needs, and the present invention is not limited thereto.

In one embodiment, as long as continuous data writing, erasing of physical units, and/or rotation of physical units occurs within the memory module 122, the error rate information and/or the time information will continuously undergo unintended variations, such that the subsequently generated encryption information based on the error rate information and/or the time information will also continuously undergo unintended variations. In this way, the randomness of the generated encryption information and the difficulty of cracking the encrypted data can be effectively improved. Thus, the data storage security of the storage device 12 can be effectively improved.

In one embodiment, before storing the encrypted data in the second physical unit, the memory control circuit 23 may perform error correction code (ECC) encoding on the encrypted data to generate error correction data. The error correction data may be used to correct errors (i.e., error bits) in the encrypted data. For example, the error correction data may carry error correction information (e.g., an error correction code) corresponding to the encrypted data.

In one embodiment, after obtaining the encrypted data and the error correction data, the memory control circuit 23 may store the encrypted data in a data region in a physical sub-unit (also referred to as first physical sub-unit) in the second physical unit. For example, the first physical sub-unit may include at least one physical programming unit in the second physical unit. In addition, the memory control circuit 23 may store the encryption information and the error correction data in a spare area in the first physical sub-unit.

In one embodiment, the memory control circuit 23 may read the encrypted data from the data region in the first physical sub-unit. In addition, the memory control circuit 23 can read the error correction data and the encryption information from the spare region in the first physical sub-unit. Then, the memory control circuit 23 can restore the encrypted data to the original data according to the error correction data and the encryption information. For example, the decode circuit 25 may decode the encrypted data read from the data region according to the error correction data to attempt to correct errors in the read encrypted data. Then, the encryption circuit 26 may decrypt the corrected encrypted data according to the encryption information to restore the original data.

In one embodiment, the memory control circuit 23 can also detect system event. The system event may include at least one of a boot event, a power-on event, and other types of custom events. For example, the custom event may include that the usage status of the storage device 12 or the memory module 122 meets a specific condition (e.g., the read count, write count, and/or erase count of the memory module 122 reaches a critical value), etc., and the present invention is not limited thereto. When the system event is detected, the memory control circuit 23 may send the read command sequence to the memory module 122 in response to the system event to obtain the read data. Thereafter, the memory control circuit 23 may perform subsequent operations according to the read data. The relevant operation details have been described above and will not be repeated here. However, if the system event is not detected, the memory control circuit 23 may not send the read command sequence to the memory module 122 to save system resources.

In one embodiment, the memory control circuit 23 may further predetermine a plurality of physical units (also referred to as candidate physical units) in the memory module 122. For example, the candidate physical units may be dispersed in different memory regions in the memory module 122. For example, each memory region may include at least one of a die, a chip enabled (CE) area, and a plane in the memory module 122.

In one embodiment, before sending the read command sequence to the memory module to obtain the read data, the memory control circuit 23 may select one of the candidate physical units as the first physical unit according to a rotation manner or other customized manner. For example, the customized manner may include, without limitation, selecting the first physical unit each time from non-adjacent physical units, among other approaches. After determining the first physical unit, the memory control circuit 23 may send the read command sequence to the memory module to obtain the read data.

In one embodiment, by distributing the candidate physical units across different components of the memory module 122 (e.g., different chips, different chip enabled (CE) regions, and/or different planes), it is possible to avoid excessive data reads from a single or limited area of the memory module 122, thereby reducing the randomness of the subsequently generated encryption information.

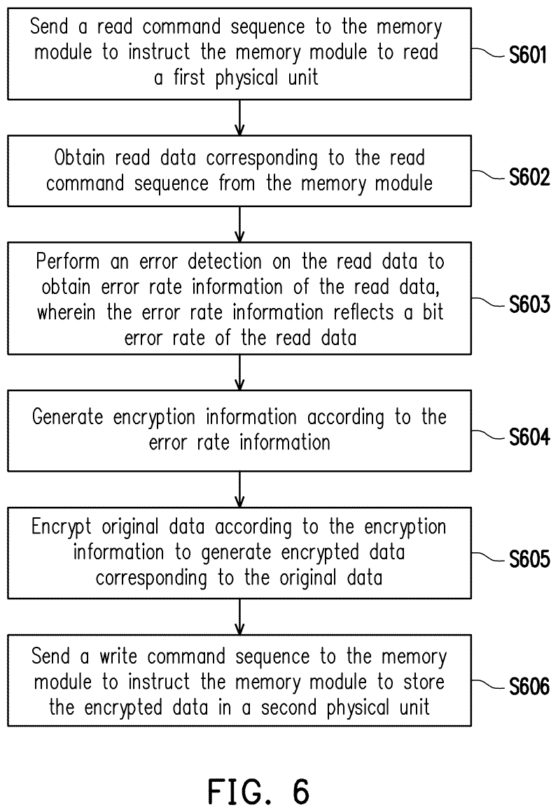

FIG. 6 is a flowchart of a memory management method according to an embodiment of the present invention. Referring to FIG. 6, in step S601, a read command sequence is sent to the memory module to instruct the memory module to read the first physical unit. In step S602, read data corresponding to the read command sequence is obtained from the memory module. In step S603, error detection is performed on the read data to obtain error rate information of the read data. The error rate information reflects the bit error rate of the read data. In step S604, encryption information is generated according to the error rate information. In step S605, the original data is encrypted according to the encryption information to generate encrypted data corresponding to the original data. In step S606, a write command sequence is sent to the memory module to instruct the memory module to store the encrypted data in the second physical unit.

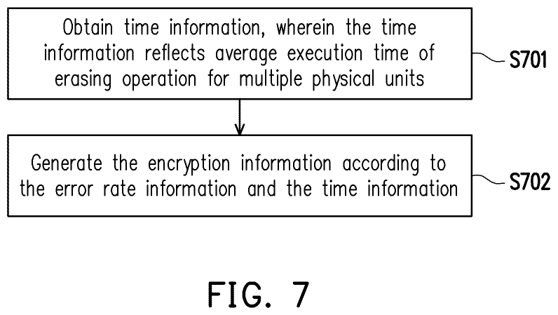

FIG. 7 is a flowchart of a memory management method according to an embodiment of the present invention. Referring to FIG. 7, in step S701, time information is obtained, wherein the time information reflects average execution time of erasing operation for multiple physical units. In step S702, the encryption information is generated according to the error rate information and the time information.

However, the steps in FIG. 6 and FIG. 7 have been described in detail above and will not be repeated here. It is noted that, each step in FIG. 6 and FIG. 7 can be implemented as multiple program codes or circuits, and the present invention is not limited thereto. In addition, the methods of FIG. 6 and FIG. 7 can be used in conjunction with the above exemplary embodiments or can be used alone, and the present invention is not limited thereto.

In summary, the memory management method and storage device provided according to the embodiments of the present invention can generate encryption information for encryption based on error rate information and/or time information. For example, minor variations in the current operation state of the memory module can be reflected to the encryption information based on the error rate information and/or the time information, thereby enhancing the randomness of the key information. As a result, this can effectively address the traditional problem of insufficient randomness in random numbers used for data encryption, thereby improving the data encryption efficiency and data storage security of the memory device.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A memory management method for a storage device, wherein the storage device comprises a memory module, the memory module comprises a plurality of physical units, and the memory management method comprises:
sending a read command sequence to the memory module to instruct reading of a first physical unit among the physical units;
obtaining read data corresponding to the read command sequence from the memory module;
performing an error detection on the read data to obtain error rate information of the read data, wherein the error rate information reflects a bit error rate of the read data;
generating encryption information according to the error rate information;
encrypting original data according to the encryption information to generate encrypted data corresponding to the original data; and
sending a write command sequence to the memory module to instruct storing of the encrypted data in a second physical unit among the physical units.

2. The memory management method according to claim 1, wherein the error detection does not comprise performing an error correction on the read data.

3. The memory management method according to claim 1, wherein the step of generating the encryption information according to the error rate information comprises:
performing a first information processing on the error rate information to obtain first reference information, wherein the first reference information complies with a default data format that matches an encryption algorithm configured to generate the encryption information; and
generating the encryption information according to the first reference information.

4. The memory management method according to claim 1, wherein the step of generating the encryption information according to the error rate information comprises:
obtaining time information, wherein the time information reflects an average execution time of erasing operations for the physical units; and
generating the encryption information according to the error rate information and the time information.

5. The memory management method according to claim 4, further comprising:
performing the erasing operations on at least one of the physical units; and
in response to the erasing operations, updating the time information.

6. The memory management method according to claim 4, wherein the step of generating the encryption information according to the error rate information and the time information comprises:
performing a first information processing on the error rate information to obtain first reference information, wherein the first reference information complies with a default data format that matches an encryption algorithm configured to generate the encryption information;
performing second information processing on the time information to obtain second reference information, wherein the second reference information complies with the default data format; and
generating the encryption information according to the first reference information and the second reference information.

7. The memory management method according to claim 6, wherein the step of generating the encryption information according to the first reference information and the second reference information comprises:
performing a scrambling processing on the first reference information and the second reference information to obtain third reference information; and
generating the encryption information according to the third reference information.

8. The memory management method according to claim 1, wherein the step of sending the read command sequence to the memory module comprises:
detecting a system event, wherein the system event comprises at least one of a boot event, a power-on event, and a custom event; and
in response to the system event, sending the read command sequence to the memory module.

9. The memory management method according to claim 1, further comprising:
pre-determining a plurality of candidate physical units among the physical units; and
before sending the read command sequence to the memory module, selecting one of the candidate physical units as the first physical unit in a rotation manner or a customized manner.

10. The memory management method according to claim 9, wherein the candidate physical units are dispersed in different memory regions in the memory module, and each of the memory regions comprises at least one of a chip, a chip enabled region, and a plane.

11. A storage device, comprising:
a connection interface, configured to connect to a host system;
a memory module; and
a memory controller, connected to the connection interface and the memory module,
wherein the memory module comprises a plurality of physical units, and the memory controller is configured to:
send a read command sequence to the memory module to instruct reading of a first physical unit among the physical units;
obtain read data corresponding to the read command sequence from the memory module;
perform an error detection on the read data to obtain error rate information of the read data, wherein the error rate information reflects a bit error rate of the read data;
generate encryption information according to the error rate information;
encrypt original data according to the encryption information to generate encrypted data corresponding to the original data; and
send a write command sequence to the memory module to instruct storing of the encrypted data in a second physical unit among the physical units.

12. The storage device according to claim 11, wherein the error detection does not comprise performing an error correction on the read data.

13. The storage device according to claim 11, wherein the operation of generating the encryption information according to the error rate information by the memory controller comprises:
performing a first information processing on the error rate information to obtain first reference information, wherein the first reference information complies with a default data format that matches an encryption algorithm configured to generate the encryption information; and
generating the encryption information according to the first reference information.

14. The storage device according to claim 11, wherein the operation of generating the encryption information according to the error rate information by the memory controller comprises:
obtaining time information, wherein the time information reflects an average execution time of erasing operations for the physical units; and
generating the encryption information according to the error rate information and the time information.

15. The storage device according to claim 14, wherein the memory controller is further configured to:
perform the erasing operations on at least one of the physical units; and
in response to the erasing operations, update the time information.

16. The storage device according to claim 14, wherein the operation of generating the encryption information according to the error rate information and the time information by the memory controller comprises:
performing a first information processing on the error rate information to obtain first reference information, wherein the first reference information complies with a default data format that matches an encryption algorithm configured to generate the encryption information;
performing second information processing on the time information to obtain second reference information, wherein the second reference information complies with the default data format; and
generating the encryption information according to the first reference information and the second reference information.

17. The storage device according to claim 16, wherein the operation of generating the encryption information according to the first reference information and the second reference information by the memory controller comprises:
performing a scrambling processing on the first reference information and the second reference information to obtain third reference information; and
generating the encryption information according to the third reference information.

18. The storage device according to claim 11, wherein the operation of sending the read command sequence to the memory module by the memory controller comprises:
detecting a system event, wherein the system event comprises at least one of a boot event, a power-on event, and a custom event; and
in response to the system event, sending the read command sequence to the memory module.

19. The storage device according to claim 11, wherein the memory controller is further configured to:
pre-determine a plurality of candidate physical units among the physical units; and
before sending the read command sequence to the memory module, select one of the candidate physical units as the first physical unit in a rotation manner or a customized manner.

20. The storage device according to claim 19, wherein the candidate physical units are dispersed in different memory regions in the memory module, and each of the memory regions comprises at least one of a chip, a chip enabled region, and a plane.
